(19) United States
(12) Patent Application Publication
(10) Pub. No.: US 2012/0037317 A1
(43) Pub. Date: Feb. 16, 2012

(54) PANEL ATTACHING DEVICE

(76) Inventor: Dong Hee Han, Gyeonggi-do (KR)

(21) Appl. No.: 13/265,913

(22) PCT Filed: Apr. 7, 2010
(86) PCT No.: PCT/KR10/02140

§ 371 Date: Oct. 24, 2011

(30) Foreign Application Priority Data
Apr. 24, 2009 (KR) 10-2009-0036175
Aug. 7, 2009 (KR) 10-2009-0072823

(51) Int. Cl. B32B 41/00; B32B 38/18

(52) U.S. Cl. 156/378

(57) ABSTRACT

A panel attaching device for attaching a first panel and a second panel comprises a first panel tilting unit for setting the first panel, adjusting the balance of the first panel and lifting up the first panel; a sensor for detecting the balance of the first panel; a second panel setting unit for setting and rotating the second panel, wherein the second panel setting unit is arranged at a predetermined distance from the first panel tilting unit; and a guide moving unit for moving the second panel setting unit to the first panel tilting unit.

In the panel attaching device according to the present invention, the balance of the first panel is adjusted and a UV curing agent is applied to the first panel or the second panel after forming a dam, so that the UV curing agent is not overflowed from the panels and the first panel and the second panel can be maintained at a regular interval, thereby being capable of manufacturing high quality of products. Further, all process for attaching is performed automatically in a short time, thereby being capable of decreasing defects and increasing productivity.

### BACKGROUND OF THE INVENTION

(1) Field of the Invention

The present invention relates to attach panels, and more particularly, to an device for attaching precisely a panel (a first panel) to another panel (a second panel) without a UV (ultraviolet) curing agent overflowing from the panels, by adjusting the balance of the first panel and applying the UV curing agent after forming a dam.

(2) Description of the Related Arts

In many electronic devices, a keyboard or mouse is used for inputting data. However, it is difficult to use the keyboard or mouse while carrying electronic devices.

Recently, a touch panel is widely used for inputting data into electronic devices. The touch panel has advantages that it is simple and easy to input data. Further, the electronic device having the touch panel does not need additional input devices and can be used while carrying.

The touch panel is arranged on the display surface of a flat panel display such as an electronic scheduler, a liquid crystal display (LCD), a plasma display panel (PDP), an electroluminescence (EL) display, etc., or a Cathode Ray Tube (CRT). The touch panel is divided into a resistive type, a capacitive type, an electro-magnetic type, a saw type, an infrared type, etc.

The type of the touch panel is selected by the amplification of signal, the difference of resolution, the difficulty of design or manufacturing, etc. In addition, the type is also selected by the optical, electrical and mechanical property of the panel. Generally, the resistive type and the capacitive type are widely used to an electronic scheduler, a personal digital assistant (PDA), a portable PC, a cellular phone, etc.

In the resistive type of touch panel, an upper electrode and a lower electrode are formed by combining a film substrate having 0.1-0.2 mm thickness, a glass substrate having 0.2-2 mm thickness and a plastic substrate having 1-2 mm thickness, and the upper electrode is formed on an upper substrate and the lower electrode is formed on a lower substrate.

When a point of the upper substrate is touched by a pen or a finger, electric current is passed between the upper electrode and the lower electrode and the resistance of the point is changed. And then, a control device searches the coordinates of the touched point by using the changed resistance.

A conventional touch panel for a LCD device includes an overlay film arranged on a surface of the LCD device, a first ITO film arranged on the lower side of the overlay film to input information into a LCD module, and a second ITO film attached to the upper surface of a substrate to input information into the LCD module.

The overlay film is arranged to protect the first ITO film and made of PET (PolyEthylene Terephthalate) film. The first ITO film is attached to the overlay film by OCA (Optical Clear Adhesive).

The first ITO film and the second ITO film include electrodes arranged on each edge thereof, and is spaced apart from each other by AG Dot (now shown). The first ITO film and the second ITO film are connected to each other by touching with a pen or a finger so that the touched position is detected.

However, in the conventional method for attaching the touch panel to the LCD module (or LCD), the balance of the touch panel and the LCD module is not considered. Therefore, there are problems that an adhesive for attaching is leaked out the outside of the touch panel or the LCD module and the distance between the touch panel and the LCD module is uneven, thereby degrading the quality of products.

### SUMMARY OF THE INVENTION

The present invention has been developed to solve the problems with above-described panel attaching device.

It is an object of the present invention to provide a panel attaching device capable of attaching precisely a first panel and a second panel at a regular interval without leaking a UV curing agent.

It is another object of the present invention to provide a panel attaching device capable of performing all process for attaching automatically in a short time, thereby being capable of manufacturing high quality of products.

Further objects will become apparent from the drawings and from the following detailed description.

In accomplishing the above and other objectives, a panel attaching device for attaching a first panel and a second panel according to the present invention comprises a first panel tilting unit for setting the first panel, adjusting the balance of the first panel and lifting up the first panel; a sensor for detecting the balance of the first panel; a second panel setting unit for setting and rotating the second panel, wherein the second panel setting unit is arranged at a predetermined distance from the first panel tilting unit; and a guide moving unit for moving the second panel setting unit to the first panel tilting unit.

A panel attaching device for attaching a first panel and a second panel according to the present invention comprises a fixing base; a first panel tilting unit for setting the first panel, adjusting the balance of the first panel and lifting up the first panel, wherein the first panel tilting unit is arranged in an upper side of the fixing base; a sensor for detecting the balance of the first panel; a second panel setting unit for setting and rotating the second panel, wherein the second panel setting unit is arranged in the other upper side of the fixing base; a dispenser for applying a UV curing agent to the first panel or the second panel; a curing unit for curing the UV curing agent; and a guide moving unit for moving the second panel setting unit to the first panel tilting unit, wherein the guide moving unit is arranged on the fixing base.

The first panel tilting unit comprises a lifting plate for lifting up and down, wherein the lifting plate is arranged on the upper side of the fixing base; a tilting plate for tilting, wherein the tilting plate is pivot-coupled to the upper side of the lifting plate on a pivot; a setting plate for setting the first panel, wherein the setting plate is fixed to the upper side of the tilting plate; a lifting servo motor for lifting up and down the setting plate, wherein the lifting servo motor is coupled to the lower surface of the lifting plate; a bearing unit arranged in the lower side of the tilting plate; and a plurality of tilting servo motors for adjusting the balance of the tilting plate on the pivot, wherein the tilting servo motors are coupled to the bearing unit or the tilting plate.

The second panel setting unit 140 comprises a vertical post arranged at a predetermined distance from the first panel tilting unit; a rotation unit arranged in the vertical post; and a setting plate for setting the second panel. The setting plate is arranged in the rotation axis of the rotation unit.

The guide moving unit comprises a moving screw coupled to the vertical post; and a servo motor for rotating the moving screw.

Another panel attaching device for attaching a first panel and a second panel according to the present invention comprises a main base; a turn table for being rotated by an index motor, wherein the turn table is arranged in the center of the main base; and a panel attaching unit for setting the first panel, adjusting the balance of the first panel, setting and rotating the second panel, and lifting up the first panel to attach the first panel to the second panel, the panel attaching unit is arranged on the turn table.

One or more of the panel attaching units may be arranged on the turn table.

In case that a plurality of the panel attaching units are arranged on the turn table, each of the panel attaching unit is maintained at a regular interval.

The panel attaching unit comprises a fixing base, a first panel tilting unit, a sensor, a second panel setting unit and a guide moving unit.

The fixing base is fixed on the turn table.

The first panel tilting unit includes a lifting plate for lifting up and down on the fixing base; a tilting plate for tilting, wherein the tilting plate is pivot-coupled to the upper side of the lifting plate on a pivot; a setting plate for setting the first panel on the upper surface thereof, wherein the setting plate is fixed to the upper side of the tilting plate; a lifting servo motor for lifting up and down the setting plate, wherein the lifting servo motor is coupled to the lower surface of the lifting plate; a bearing unit arranged in the lower side of the tilting plate; and a plurality of tilting servo motors for adjusting the balance of the tilting plate on the pivot, wherein the tilting servo motors are coupled to the bearing unit or the tilting plate.

The sensor detects the balance of the first panel absorbed on the setting plate.

The second panel setting unit includes a vertical post arranged in a predetermined distance from the first panel tilting unit; a rotation unit arranged in the vertical post; and a setting plate for setting the second panel. The setting plate is arranged on a rotation axis of the rotation unit.

The guide moving unit is arranged on the fixing base and moves the second panel setting unit to the first panel tilting unit.

The panel attaching unit includes a dispenser for applying a UV curing agent to the first panel or the second panel; and a curing unit for curing the UV curing agent.

In the panel attaching device according to the present invention, the balance of the first panel is adjusted and a UV curing agent is applied to the first panel or the second panel after forming a dam, so that the UV curing agent is not overflowed from the panels and the first panel and the second panel can be maintained at a regular interval, thereby being capable of manufacturing high quality of products.

Further, all process for attaching is performed automatically in a short time, thereby being capable of decreasing defects and increasing productivity.

### BRIEF DESCRIPTION OF THE DRAWINGS

FIG. 1 is a front view showing the panel attaching device according to an embodiment of the present invention.

FIG. 2 is a side view showing the panel attaching device of FIG. 1.

FIG. 3 is a top view showing the panel attaching device of FIG. 1.

FIG. 4 is a top view showing the panel attaching device according to another embodiment of the present invention.

FIG. 5 is a front view showing a panel attaching unit in the panel attaching device of FIG. 4.

FIG. 6 is a side view showing a panel attaching unit in the panel attaching device of FIG. 4.

FIG. 7 is a top view showing a panel attaching unit in the panel attaching device of FIG. 4.

(Description of Reference Numerals)

| P1: fist panel | P2: second panel |
|---|---|
| B: main base | T: turn table |
| 100: panel attaching unit | L: loading unit |
| 110: fixing base | |
| 120: first panel tilting unit | |
| 121: fixing plate | 122: guider |
| 123: lifting plate | pv1: pivot |
| 124: tilting plate | 125: setting plate |
| 126: lifting servo motor | 127: bearing unit |
| pv2: pivot | |
| 128, 128′: tilting servo motor | |
| 130: sensor | |
| 140: second panel setting unit | |
| 141: vertical post | 142: rotation unit |
| 142a: rotation axis of rotation unit | |
| 150: guide moving unit | 151: moving screw |
| 153: servo motor | |

### DETAILED DESCRIPTION OF THE EMBODIMENTS

Referring now to attaching the drawings, a panel attaching device according to an embodiment of the present invention will be described in detail.

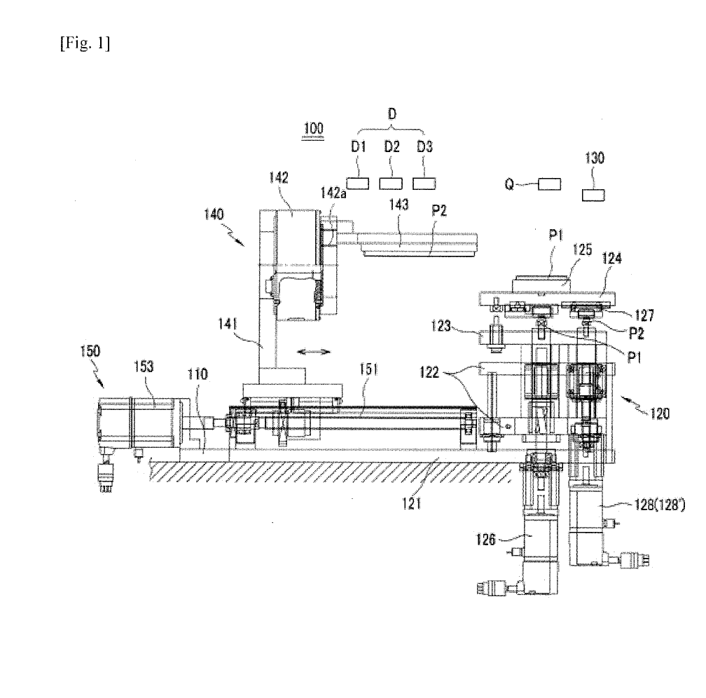

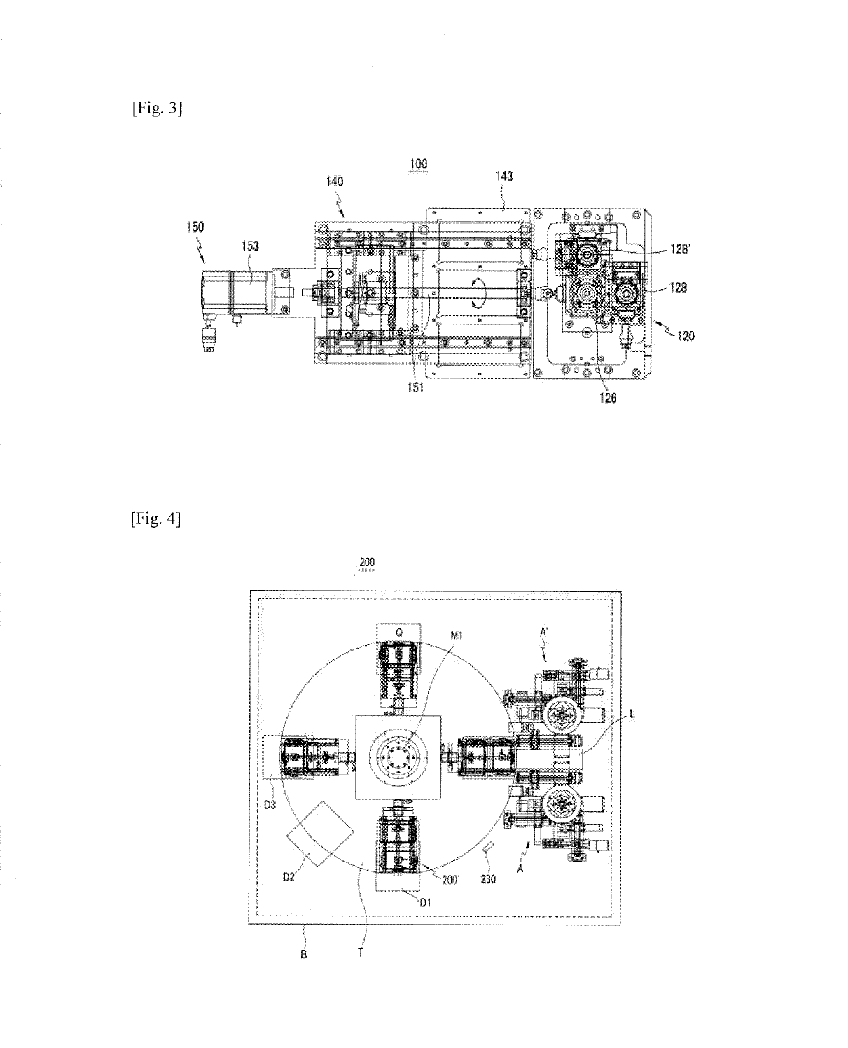

FIG. 1 to FIG. 3 illustrate a rigid structure of a panel attaching device capable of fixing on the ground or a movable plate according to an embodiment of the present invention, and FIG. 4 to FIG. 7 illustrate a turn table structure of a panel attaching device according to another embodiment of the present invention.

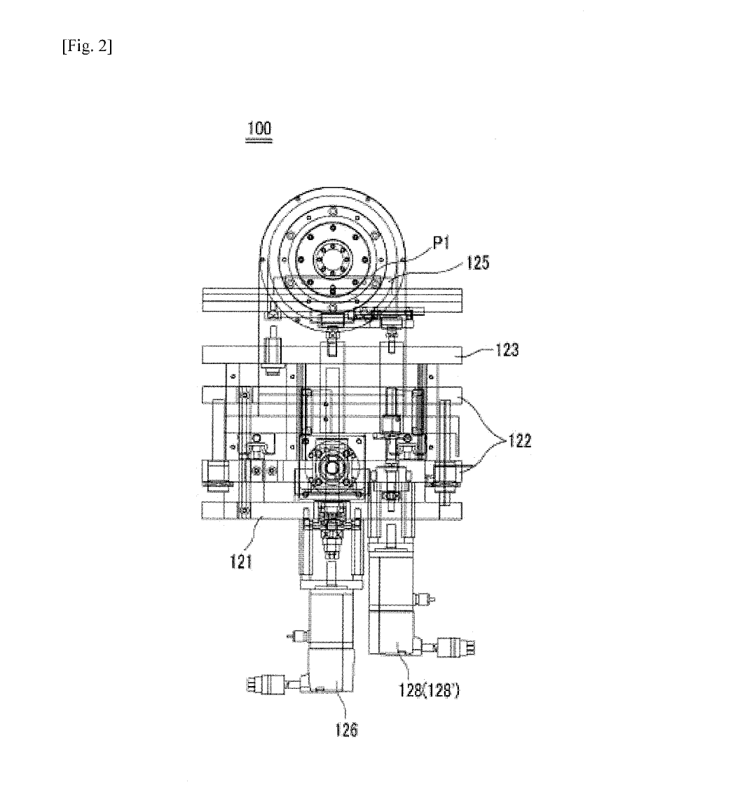

FIG. 1 is a front view of a panel attaching device according to an embodiment of the present invention, FIG. 2 is a side view of the panel attaching device of FIG. 1, and FIG. 3 is a top view of the panel attaching device of FIG. 1.

As shown FIG. 1 to FIG. 3, the panel attaching device 100 according to an embodiment of the present invention attaches a first panel P1 to a second panel P2. The panel attaching device includes a fixing base 110; a first panel tilting unit 120 for setting the first panel P1, adjusting the balance of the first panel P1 and lifting up the first panel P1 to press the first panel P1 and the second panel P2, wherein the first panel tilting unit 120 is arranged in an upper side of the fixing base 110; a sensor 130 for sensing the balance of the first panel P1; a second panel setting unit 140 for setting and rotating the second panel P2, wherein the second panel setting unit 140 is arranged on the other upper side of the fixing base 110; a dispenser D for applying a UV curing agent to the first panel P1 or the second panel P2; a curing unit Q for curing the UV curing agent; and a guide moving unit 150 for moving the second panel setting unit 140 to the first panel tilting unit 120, wherein the guide moving unit 150 is arranged on the fixing base 110.

The first panel P1 and the second panel P2, for example, may be a touch screen panel (TSP), a window, a LCD module or LCD device. In addition, a substrate, a film, etc. are used as the first panel P1 or the second panel P2.

The panel attaching device 100 according to an embodiment of the present invention is useful in cases where the panels should be attached to each other while maintaining the balance.

A loading unit (not shown) and a pre-processing unit (not shown) may be arranged in the preceding part of the panel attaching device 100. The loading unit loads the first panel P1 and the second panel P2 to the panel attaching device 100 and the pre-processing unit adjacent to the loading unit pre-processes the first panel P1 and the second panel P2 before providing the first panel P1 and the second panel P2 to the panel attaching device 100.

The panel attaching device 100 includes a fixing base 110, a first panel tilting unit 120, a sensor 130, a second panel setting unit 140, a dispenser D, a curing unit Q and a guide moving unit 150.

First, the fixing base 110 is provided and a fixing plate 121 is arranged and fixed in the fixing base 110. A guider 122 is arranged in the upper side of the fixing plate 121. A lifting plate 123 for lifting up and down is arranged in the upper side of the guider 122. Alternatively, the lifting plate 123 may be arranged to lift up and down perpendicularly on the fixing base 110 by using another means. It is well known that the lifting plate 123 is arranged to lift up and down on the fixing base 110 by various other methods, so that the detailed explanation thereabout is omitted here.

A tilting plate 124 is coupled to the upper side of the lifting plate 123 to tilt on a pivot pv1.

A setting plate 125 is fixed to the upper side of the tilting plate 124, and the first panel P1 is set on the upper surface of the setting plate 125. A lifting servo motor 126 is coupled to the lower surface of the lifting plate 123 so that the setting plate 125 can be lifted up and down. A bearing unit 127 is arranged in the lower side of the tilting plate 124. A plurality of tilting servo motors 128, 128′ is coupled to the bearing unit 127 or the tilting plate 124 on a pivot pv2, so that the balance of the tilting plate 124 can be adjusted.

The sensor 130 detects the balance of the first panel P1. In case of sensing of the balance by the sensor, the sensor may be contacted to the panel or non-contacted to the panel such as an optical sensor. It is well known that the balance of the panel is detected by the sensor, so that the detailed explanation thereabout is omitted here.

The second panel setting unit 140 includes a vertical post 141, a rotation unit 142 and a setting plate 143.

First, the vertical post 141 is arranged at a regular distance from the first panel tilting unit 120.

The rotation unit 142 is arranged in the vertical post 141. The setting plate 143 is arranged the rotation axis 142a of the rotation unit 142, and the second panel P2 is set on the setting plate 143.

The setting plates 125, 143 have a vacuum hole (not shown) for adsorbing and fixing the first panel P1 and the second panel P2. The vacuum hole is well known, so that the detailed explanation thereabout is omitted here.

It is desirable that the setting plate 143 for setting the second panel P2 is made of materials such as glass, acryl, etc., through which light can transmit. Because the curing process is performed by irradiating UV light, the efficiency of curing is increased by using the setting plate 143 made of transparent materials through which light can transmit.

The rotation unit 142 may be a DD motor or a servo motor, and replaced by other devices having the same or similar function.

The dispenser D applies a UV curing agent to the surface of the first panel P1 or the second panel P2. The dispenser D comprises a dispenser D1 for applying a dam shaped UV curing agent to the outer surface of the first panel P1 or the second panel P2, and dispensers D2, D3 for applying the UV curing agent to the whole surface of the first panel P1 or the second panel P2. Alternatively, only one dispenser D can apply simultaneously the dam shaped UV curing agent to the surface of the second panel P2 and the UV curing agent to the surface of the first panel P1 or the second panel P2.

As described above, after forming the dam on the first panel P1 or the second panel P2, the UV curing agent is applied to the first panel P1 or the second panel P2. Thus, by the dam, the UV curing agent is not overflowed from the attached panels and not exposed to the outside after attaching the first panel P1 and the second panel P2, thereby being capable of manufacturing high quality of products.

The curing unit Q for curing the UV curing agent performs an process for curing the dam shaped UV curing agent formed on the surface of the first panel P1 or the second panel P2 and the other process for curing the UV curing agent applied on the surface of the first panel P1 or the second panel P2. According to process or design conditions, one or more curing units Q can be arranged.

The dam can be formed by a dot, a polyhedron or a stick shaped spacer. That is, by using the UV curing agent, a dot, a polyhedron or stick shaped spacer is formed continuously in the outer surface of the panel or formed on a part or whole surface of the panel, and then the UV curing agent is cured by irradiating UV light. The spacer can be formed by a printing process using a mask pattern.

The guide moving unit 150 comprises a moving screw 151 for coupling with the vertical post 141 and a servo motor 153 for rotating the moving screw 151.

Next, the operation of the panel attaching device 100 according to an embodiment of the present invention will be described.

The first panel P1 is loaded on the setting plate 125 of the first panel tilting unit 120, and the second panel P2 is loaded on the setting plate 143 of the second panel setting unit 140.

The sensor detects the balance of the first panel P1 set on the setting plate 125. The tilting servo motors 128, 128′ are driven to tilt the tilting plate 124 on the pivot pv1 so that the balance of the first panel is adjusted.

The dam made of the UV curing agent is formed on the first panel P1 or the second panel P2 by the dispensers D, D1. And then, the curing unit Q cures the dam shaped UV curing agent formed on the surface of the first panel P1 or the second panel P2.

The curing unit Q has a UV radiation lamp arranged in the curing position and radiates UV light to the UV curing agent. The operation of the curing unit Q is well known, so that the detailed explanation thereabout is omitted here.

The dispensers D, D2 apply the UV curing agent on the surface of the first panel P1 or the second panel P2. The second curing agent may be applied on surface of the first panel P1 or the second panel P2 by another dispensers D, D3.

One or more dispensers are arranged according to the process design.

Generally, above described dispenser D is used to dispense a viscosity solution such as epoxy resin so that surface mounted components such as chips or ICs is mounted on a printed circuit board (PCB) or a panel. The dispenser D is also used to a flip chip under-fill process which applies an adhesive and seals around chips to protect semiconductor devices from outside environment. The operation of the dispenser is well known, so that the detailed explanation thereabout is omitted here.

The servo motor 153 of the guide moving unit 150 rotates the moving screw 151, and then the vertical post 141 coupled in the moving screw 151 moves toward the first panel tilting unit 120.

The rotation unit 142 rotates the second panel P2 in a 180 degree. Then the lifting servo motor 126 is driven to lift up the setting plate 125 so that the first panel P1 and the second panel P2 are pressed and adhered closely.

Next, the curing unit Q cures and attaches the first panel P1 and the second panel P2.

After attaching the panels, the first panel P1 and the second panel P2 are unloaded to the outside of the panel attaching device 100.

As described above, in the panel attaching device according to the present invention, the first panel P1 and the second panel P2 are attached while adjusting precisely the balance of the first panel P1, so that the UV curing agent is not overflowed during attaching panels and the first panel P1 and the second panel P2 are maintained at a regular interval. Therefore, high-quality of products can be manufactured by the panel attaching device.

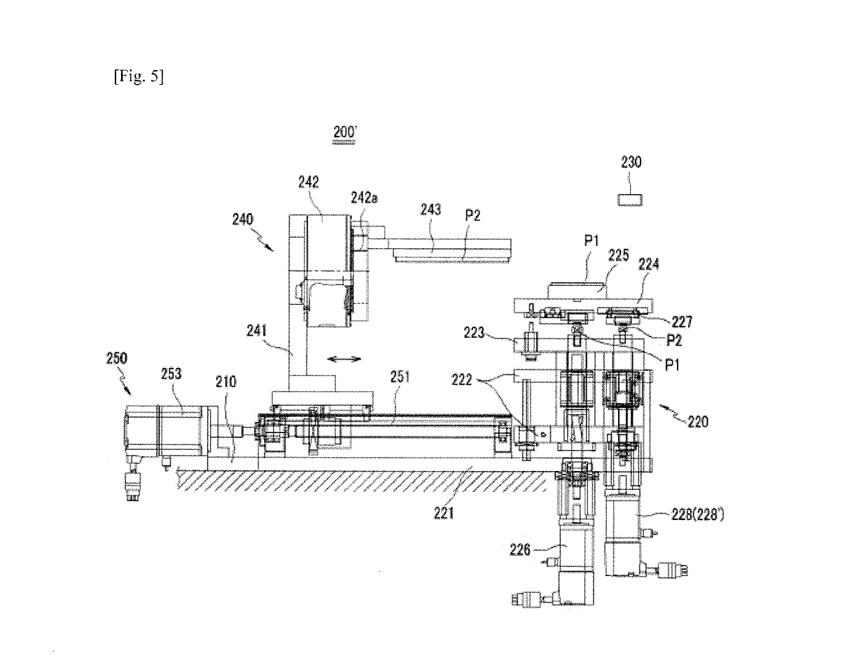

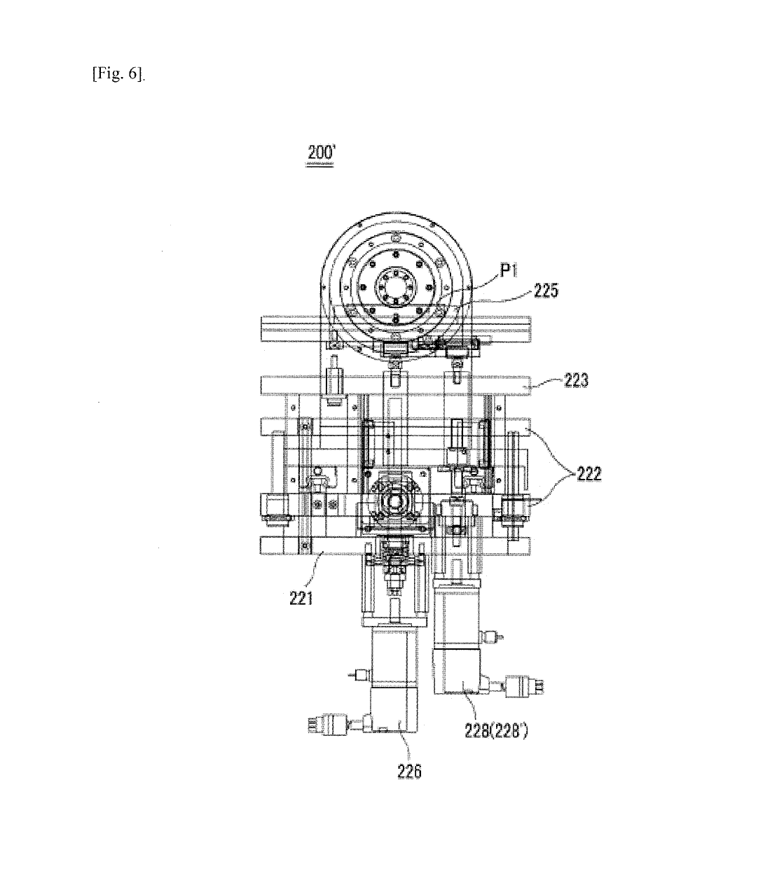

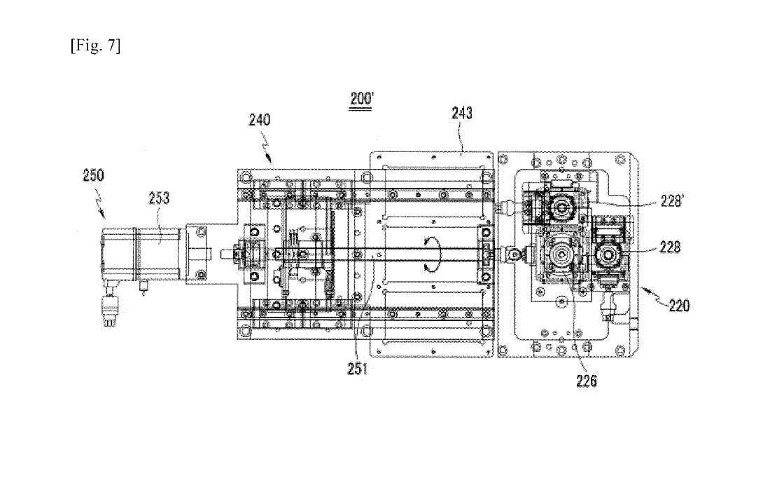

FIG. 4 is a top view showing a panel attaching device according to another embodiment of the present invention, FIG. 5 is a front view showing a panel attaching unit in the panel attaching device of FIG. 4, FIG. 6 is a side view showing the panel attaching unit in the panel attaching device of FIG. 4, and FIG. 7 is a top view showing the panel attaching unit in the panel attaching device of FIG. 4.

In FIG. 4 to FIG. 7, four panel attaching units are arranged uniformly on the turn table T. However, alternatively, one or more panel attaching units 200′ are arranged on the turn table T.

In case that one panel attaching unit 200′ is arranged, the processes for attaching are controlled easily.

Otherwise, in case that a plurality of panel attaching units is arranged, the processes for attaching have a high degree of efficiency. The plurality of panel attaching units can be arranged at a regular interval, or at a different interval according to the process design.

The panel attaching device 200 according to another embodiment of the present invention comprises a main base B; a turn table T for being rotated by an index motor M1, wherein the turn table T is arranged in the center of the main base B; and a panel attaching unit 200′ for setting the first panel P1, adjusting the balance of the first panel P1, setting and rotating the second panel P2, and lifting up the first panel P1 to attach the first panel P1 to the second panel P2, wherein the panel attaching unit 200′ is arranged on the turn table T.

In addition, the panel attaching unit 200′ further comprises a loading unit L for loading the first panel P1 and the second panel P2 to the panel attaching device 200 and pre-processing units A, A′ for pre-processing the first panel P1 and the second panel P2.

The panel attaching unit 200′ includes a fixing base 210, a first panel tilting unit 220, a sensor 230, a second panel setting unit 240 and a guide moving unit 250.

The fixing base 210 is fixed on the turn table T. A fixing plate 221 is arranged and fixed on the fixing base 210. A guider 222 is arranged on the upper side of the fixing plate 221, and a lifting plate 223 is arranged on the upper side of the guider 222 to lift up and down.

Instead of being arranged on the fixing plate 221 and the guider 222, the lifting plate 223 is arranged directly on the fixing base 210 to lift up and down perpendicularly.

A tilting plate 224 is coupled on the upper side of the lifting plate 223 to tilt on a pivot pv1.

A setting plate 225 is fixed on the upper side of the tilting plate 224, and the first panel P1 is set on the upper surface of the setting plate 225. The lifting servo motor 226 is coupled on the lower surface of the lifting plate 223 to lift up and down the setting plate 225. A bearing unit 227 is arranged on the lower side of the tilting plate 224. A plurality of tilting servo motors is coupled to the tilting plate 224 to adjust the balance of the tilting plate 224 on a pivot pv2.

The second panel setting unit 240 includes a vertical post 241, a rotation unit 242 and a setting plate 243.

The vertical post 241 is arranged in a predetermined distance from the first panel tilting unit 220. The rotation unit 242 is arranged in the vertical post 241. The setting plate 243 for setting the second panel P2 is arranged on a rotation axis 242a of the rotation unit 243.

The panel attaching unit 200′ has a dispenser D for applying a UV curing agent to the first panel P1 or the second panel P2. The panel attaching unit 200′ includes one or more dispensers. The dispenser D applies a dam shaped UV curing agent to the surface of the first panel (or the second panel), and applies a UV curing agent to the surface of the first panel (or the second panel).

The panel attaching unit 200′ has a curing unit Q for curing the UV curing agent. One or more curing units Q are arranged according to a process design. The curing unit Q irradiates UV light on the UV curing agent applied by the dispenser D, so that the UV curing agent is cured.

The guide moving unit 250 of the panel attaching unit 200′ is arranged on the fixing base 210. The guide moving unit 250 can move the second panel setting unit 240 to the first panel tilting unit 220.

The guide moving unit 250 has a moving screw 251 for coupling with the vertical post 241 and a DD motor or a servo motor 253 for rotating the moving screw 251.

Next, the operation of the panel attaching device 200 according to another embodiment of the present invention will be described.

First, the first panel P1 is pre-processed by the pre-processing unit A, and then loaded on the setting plate 223 of the first panel tilting unit 220 by the loading unit L. At the same time, the second panel P2 is pre-processed by the pre-processing unit A′, and then loaded on the setting plate 243 of the second panel setting unit 240 by the loading unit L.

The index motor M1 rotates the turn table T at a predetermined angle so that the panel attaching unit 200′ is moved to a predetermined position.

The sensor 230 detects the balance of the first panel P1 set on the setting plate 223 and the tilting servo motors 228, 228′ are driven to tilt the tilting plate 224 on the pivot pv1, so that the balance of the first panel P1 is adjusted.

The index motor M1 rotates the turn table T at a predetermined angle, so that the panel attaching unit 200′ is moved to a predetermined position.

The dispenser D, D1 forms a dam of the UV curing agent on first panel P1 or the second panel P2. Next, the curing unit Q cures the dam shaped UV curing agent formed on the first panel P1 or the second panel P2.

The index motor M1 rotates the turn table T at a predetermined angle, so that the panel attaching unit 200′ is moved to a predetermined position.

The dispensers D, D3 apply the UV curing agent on the whole surface of the first panel P1 or the second panel P2.

The index motor M1 rotates the turn table at a predetermined angle, so that the panel attaching unit 200′ is moved to a predetermined position.

The servo motor 253 of the guide moving unit 250 rotates the moving screw 251, and then the vertical post 241 coupled with the moving screw 251 moves to the first panel tilting unit 220.

The rotation unit 242 rotates the second panel P2 in a 180 degree. And, the lifting servo motor 226 is driven to lift up the setting plate 225 so that the first panel P1 and the second panel P2 is pressed and adhered closely.

Next, the curing unit Q cures and attaches the first panel P1 and the second panel P2.

After attaching the panels, the attached the first panel P1 and the second panel P2 are unloaded to the outside of the panel attaching device 200.

As described above, in the panel attaching device according to the present invention, the first panel P1 and the second panel P2 are attached by adjusting the balance of the first panel precisely and applying the UV curing agent after forming the dam, so that the UV curing agent is not overflowed from the attached panels.

Further, the dam is formed in a predetermined height so that the distance from first panel P1 to the second panel P2 is maintained at a regular interval. Therefore, the panel attaching device according to the present invention has the effect of improving the quality of products.

Further, in the panel attaching device according to the present invention, all process for attaching the panels performs automatically in a short time, thereby decreasing defects and increasing productivity.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A panel attaching device for attaching a first panel and a second panel, the device comprising:
a first panel tilting unit for setting the first panel, adjusting the balance of the first panel and lifting up the first panel;
a sensor for detecting the balance of the first panel;
a second panel setting unit for setting and rotating the second panel, wherein the second panel setting unit is arranged at a predetermined distance from the first panel tilting unit; and
a guide moving unit for moving the second panel setting unit to the first panel tilting unit.

2. A panel attaching device for attaching a first panel and a second panel, the device comprising:
a fixing base;
a first panel tilting unit for setting the first panel, adjusting the balance of the first panel and lifting up the first panel, wherein the first panel tilting unit is arranged in an upper side of the fixing base;
a sensor for detecting the balance of the first panel;
a second panel setting unit for setting and rotating the second panel, wherein the second panel setting unit is arranged in the other upper side of the fixing base;
a dispenser for applying a UV curing agent to the first panel or the second panel;
a curing unit for curing the UV curing agent; and
a guide moving unit for moving the second panel setting unit to the first panel tilting unit, wherein the guide moving unit is arranged on the fixing base.

3. The panel attaching device according to claim 1 or 2, wherein the first panel tilting unit comprising:
a lifting plate for lifting up and down, wherein the lifting plate is arranged on the upper side of the fixing base;
a tilting plate for tilting, wherein the tilting plate is pivot-coupled to the upper side of the lifting plate on a pivot;
a setting plate for setting the first panel, wherein the setting plate is fixed to the upper side of the tilting plate;
a lifting servo motor for lifting up and down the setting plate, wherein the lifting servo motor is coupled to the lower surface of the lifting plate;
a bearing unit arranged in the lower side of the tilting plate; and
a plurality of tilting servo motors for adjusting the balance of the tilting plate on the pivot, wherein the tilting servo motors are coupled to the bearing unit or the tilting plate.

4. The panel attaching device according to claim 1 or 2, wherein the second panel setting unit comprising:
a vertical post arranged at a predetermined distance from the first panel tilting unit;
a rotation unit arranged in the vertical post; and
a setting plate for setting the second panel, wherein the setting plate is arranged in the rotation axis of the rotation unit.

5. The panel attaching device according to claim 4, wherein the setting plate for setting the second panel is made of materials through which light can transmit.

6. The panel attaching device according to claim 1 or 2, wherein the guide moving unit comprising:
a moving screw coupled to the vertical post; and
a servo motor for rotating the moving screw.

7. A panel attaching device for attaching a first panel and a second panel, the device comprising:
a main base;
a turn table for being rotated by an index motor, wherein the turn table is arranged in the center of the main base; and
a panel attaching unit for setting the first panel, adjusting the balance of the first panel, setting and rotating the second panel, and lifting up the first panel to attach the first panel to the second panel, the panel attaching unit is arranged on the turn table.

8. The panel attaching device according to claim 7, wherein one or more of the panel attaching units are arranged on the turn table.

9. The panel attaching device according to claim 8, wherein in case that a plurality of the panel attaching units are arranged on the turn table, each of the panel attaching unit is maintained at a regular interval.

10. The panel attaching device according to one of claims 7 to 9, wherein the panel attaching unit comprising:
a fixing base fixed on the turn table;
a first panel tilting unit which includes
a lifting plate for lifting up and down on the fixing base;
a tilting plate for tilting, wherein the tilting plate is pivot-coupled to the upper side of the lifting plate on a pivot;
a setting plate for setting the first panel on the upper surface thereof, wherein the setting plate is fixed to the upper side of the tilting plate;
a lifting servo motor for lifting up and down the setting plate, wherein the lifting servo motor is coupled to the lower surface of the lifting plate;
a bearing unit arranged in the lower side of the tilting plate; and
a plurality of tilting servo motors for adjusting the balance of the tilting plate on the pivot, wherein the tilting servo motors are coupled to the bearing unit or the tilting plate;
a sensor for detecting the balance of the first panel absorbed on the setting plate;
a second panel setting unit which includes
a vertical post arranged in a predetermined distance from the first panel tilting unit;
a rotation unit arranged in the vertical post; and
a setting plate for setting the second panel, wherein the setting plate is arranged on a rotation axis of the rotation unit; and
a guide moving unit for moving the second panel setting unit to the first panel tilting unit, wherein the guide moving unit is arranged on the fixing base.
